(19) United States
(12) Patent Application Publication
(10) Pub. No.: US 2009/0051933 A1
(43) Pub. Date: Feb. 26, 2009

(54) Tool Detection

(75) Inventors: Victor Gordon Stimpson, Avening (GB); William Kenneth Davies, Bristol (GB)

Correspondence Address: OLIFF & BERRIDGE, PLC, P.O. BOX 320850, ALEXANDRIA, VA, 22320-4850, US

(73) Assignee: Renishaw PLC, Wotton-Under-Edge (GB)

(21) Appl. No.: 12/224,125

(22) PCT Filed: Feb. 16, 2007
(86) PCT No.: PCT/GB2007/000533

§ 371 Date: Aug. 19, 2008

(30) Foreign Application Priority Data
Feb. 24, 2006 (GB) 0603653.7

(51) Int. Cl. G01B 11/14

(52) U.S. Cl. 356/614

(57) ABSTRACT

An object detection apparatus and a method for calibrating an object detection apparatus. The apparatus comprises a housing provided with a light source and a light detector. The light source directs a beam of light towards the light detector. The housing has a base which is provided with a datum surface. The light beam has a defined distance and angle from the datum base. The method for calibrating an object detection apparatus involves setting threshold levels for light intensity received at the light detector. The apparatus has two modes of operation. The invention also includes an adapter for an object detection apparatus which detects the presence of an object by obstructing a light path.

The present invention relates to the detection of objects, e.g. cutting tools for use on machine tools. In particular, the invention relates to the determination of the diameter of the cutting tool, and the position of its tip.

A machine tool uses a variety of tools, which can be stored in a carousel whilst inoperative. When one tool is selected its specific characteristics, e.g. diameter and tip position, must be determined before it can be used. It is desirable to determine such tool characteristics quickly and accurately. By decreasing the time taken and increasing the accuracy for setting tools, machine productivity can be increased, and scrap can be reduced.

One known arrangement to detect the position of the tip of a tool with respect to the spindle of the machine tool in which it is mounted involves moving the spindle until the tool touches onto the surface of a work piece mounted on the bed of a machine tool. The machine co-ordinates at this position are noted and the position of the tip of the tool thus determined. This method is time consuming, unwieldy, and may cause damage to the surface of the work piece. An alternative arrangement avoids damaging the surface by using a slip-gauge of known dimensions between the surface and the tool tip, however this is still a time consuming and awkward process.

A known tool setting device for use on a machine tool includes a light source which generates a fine beam of light which is incident upon a detector. During a toolsetting operation, the machine is operated to move the tool in a direction transverse to the direction of propagation of the light beam until a part of the tool interrupts passage of the light beam. Detection of this interruption results in the generation of a trigger signal in the detecting unit, which is used by the machine to establish the relative position of its moving parts in order to determine dimensions of the tool. Such devices are known, for example from German patent Nos. DE 42 385 04 and DE 42 448 69, French patent No. 2,343,555, European patent Nos. 98,930 and U.S. Pat. No. 4,518,257. The devices may be used additionally for measuring the length or diameter of a tool to monitor breakage or wear.

It is also known to provide an array of light detectors, e.g. in the form of a charge-coupled device (CCD). This is described in international patent application WO 2005/085753.

Tool setting apparatus, which detect the width and/or tip position of tools, are typically mounted permanently on the bed of the machine tool taking up valuable working space. This has the disadvantage that one tool setting apparatus is required for each machine. Consequently if a number of machines are in use, providing them each with a tool setting apparatus can be very costly. Also, as the tool setter is mounted in the machine, it must be sufficiently robust to withstand extreme conditions such as high temperature, and contaminants such as swarf and coolant.

A first aspect of the present invention provides an object detection apparatus comprising:
a housing;
a light source and a light detector provided in the housing, the light source directing a beam of light towards the light detector; and
the housing having a base which is provided with a datum surface, wherein the light beam has a defined distance and angle from the datum surface.

The datum surface and its predefined relationship with the light path enables the apparatus to be simply placed on a surface ready for use, with no adjustments or calibration required. This enables the apparatus to be removable and has the further advantage that it does not have to withstand extreme conditions such as high temperature, and contaminants such as swarf and coolant.

Preferably the light path between the light source and light detector lies substantially parallel to the datum surface. This allows the position of the tip of the object to be determined with respect to the surface the datum surface sits on, for example the bed of a machine tool or a work piece mounted on a machine tool.

Preferably the light source is an LED. Preferably the LED is mounted with the bond wire at the side. However, the light source may also comprise for example a laser. The light source may be pulsed. This has the advantage of extending the battery life and allowing the light source to work at a current higher than would be possible if it was run continuously. In a preferred embodiment the light detector is also pulsed and synchronised with the pulses of the light source.

A ball lens may be positioned in front of the light source. This helps to give a more uniform light distribution across the detector, which may comprise a light-receiving array.

Preferably the light detector is an array of light sensitive elements. The array may comprise a linear array. More preferably the linear array is a CMOS sensor. However the light-receiving array may also comprise for example a charge-coupled device (CCD) or an array of individual photodiodes.

A second aspect of the present invention provides an object detection apparatus comprising a light source and a light detector, the light source directing light towards the detector;
wherein the light detector comprises an array of light sensitive elements; and
wherein the apparatus has a first mode of operation in which a first set of the light sensitive elements are operational and a second mode of operation in which a second set of the light sensitive elements are operational.

Preferably the second set of the light sensitive elements is a subset of the first set. The first set may comprise all the elements in the array. The second set may comprise a single element.

A third aspect of the invention provides a method for detecting the diameter of an object using an object detection apparatus comprising a light source and a light detector, the light source directing a light beam toward the detector, the method comprising the following steps in any suitable order:
moving said object into the path of the light beam from a first side of the light beam and determining the position of the object when the light beam is broken;
moving said object into the path of the light beam from a second side of the light beam, said second side being opposite to the first side, and determining the position of the object when the light beam is broken; and
using the difference between these positions to determine the diameter of the object.

Preferably, the position of the object is determined when the light intensity detected by the detector is 50% of its original value when the object is not in the detectable light path. This enables simple calculation of the diameter of the object.

A fourth aspect of the invention further provides a method for calibrating an object detection apparatus, having a light source and a light detector comprising an array of light sensitive elements, the light source directing light towards the detector, the method comprising the following steps, in any suitable order:
measuring the intensity of light incident on each individual element of the array when no object is present between the light source and detector;
calculating a predetermined percentage of the measured light intensity value measured at each element; and
setting the percentage value of each element as a threshold level for that element.

The method may have the additional steps of:
comparing the output of each light-sensitive element with the output of the threshold value of that element; and
producing a signal to indicate when the light intensity at any one element drops below its threshold value.

This thereby indicates the presence of an object between the light source and the light detector.

A fifth aspect of the invention provides an adapter for an object detection apparatus which detects the presence of an object by obstructing a light path, the adapter comprising:
a housing; and
a plunger mounted within the housing and movable with respect to the housing;
a biasing means acting on the plunger;
the plunger having a surface against which an object may be pushed to move the plunger relative to the housing against the bias of the biasing means.

The adapter enables an object that is too large to be measured directly by the object detecting apparatus to be measured indirectly using an adapter.

Preferably the housing is configured so that the adapter is mounted in the light path of an object detection apparatus, the housing does not obstruct the light path. It may be c-shaped for example.

Preferred embodiments of the invention will now be described by way of example and with reference to the accompanying drawing, wherein:

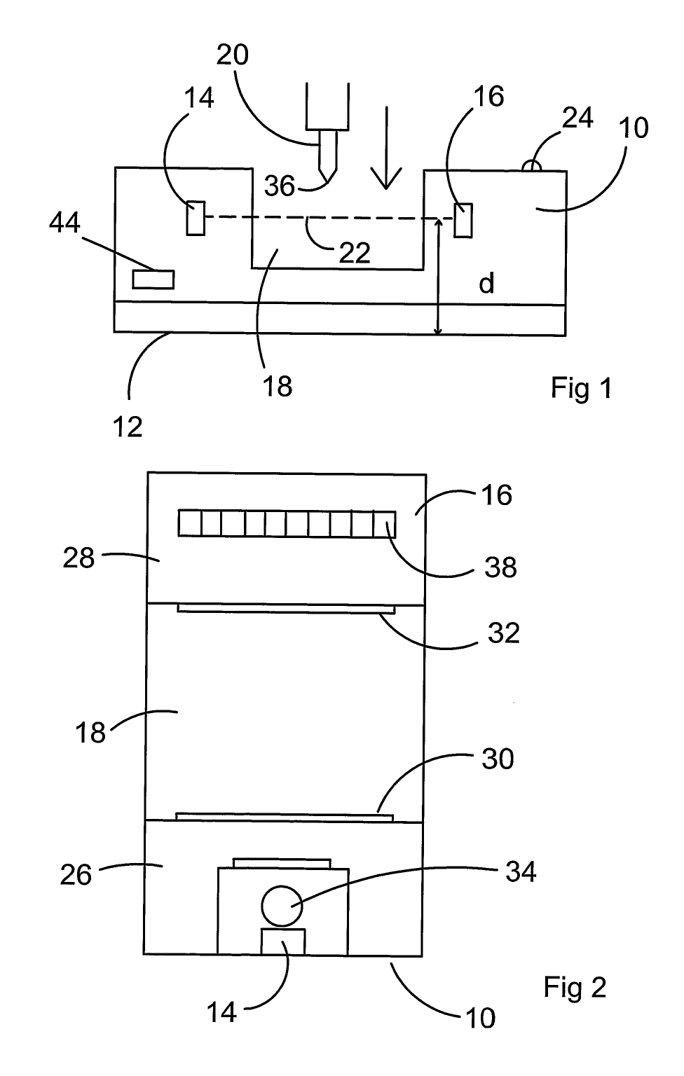

FIG. 1 shows a side view of the apparatus according to the invention;

FIG. 2 shows a plan view of the apparatus according to the invention;

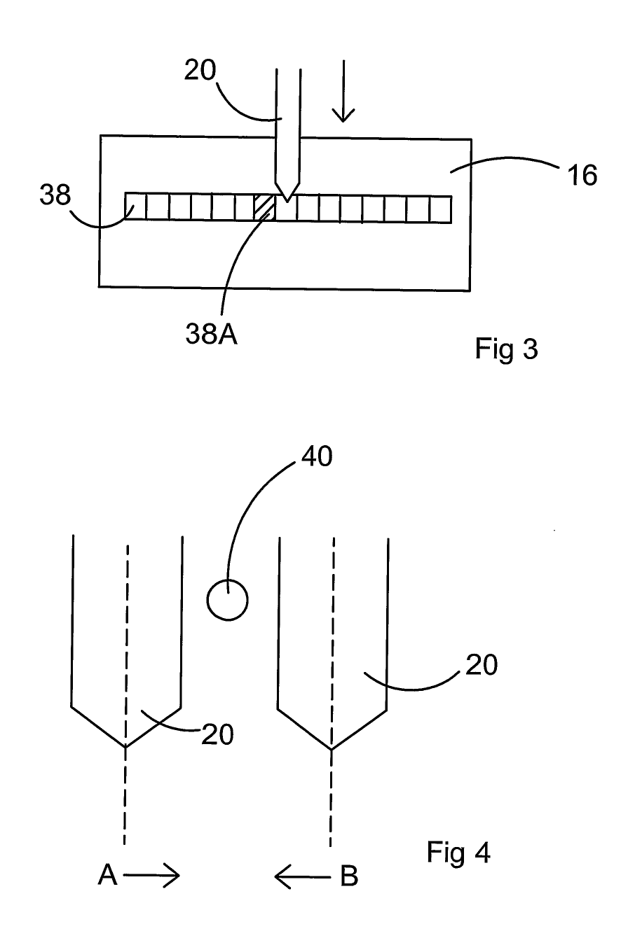

FIG. 3 shows the detector array and a tool (in a first mode of use of the apparatus according to the invention);

FIG. 4 shows a cross section of the light beam and the tool in two positions in a second mode of use of the apparatus according to the invention;

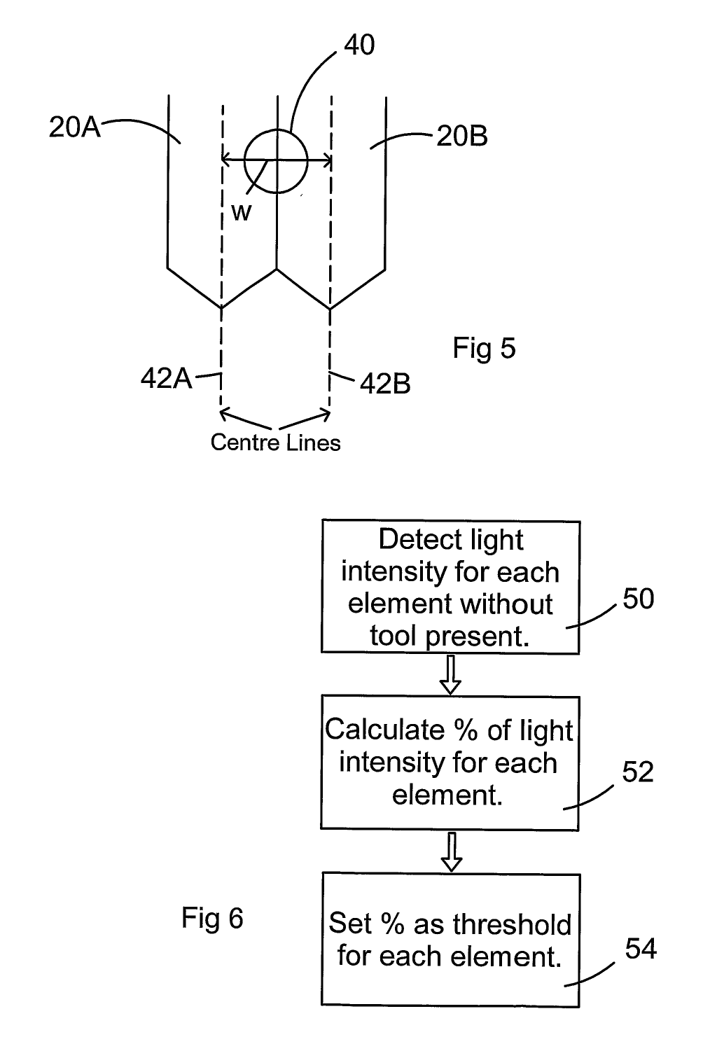

FIG. 5 shows the arrangement of FIG. 4 with the tool in positions to create a trigger signal;

FIG. 6 shows a flow diagram describing the method for setting the thresholds for the individual light detecting elements;

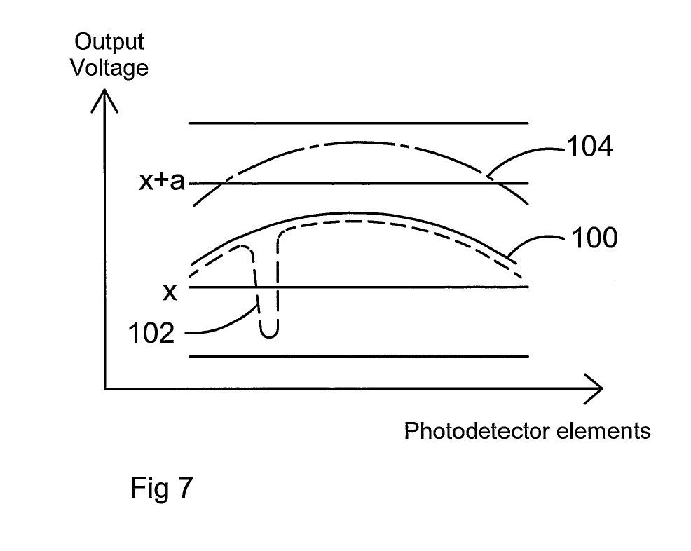

FIG. 7 is a graph showing the relationship between photo-detector elements and voltage output;

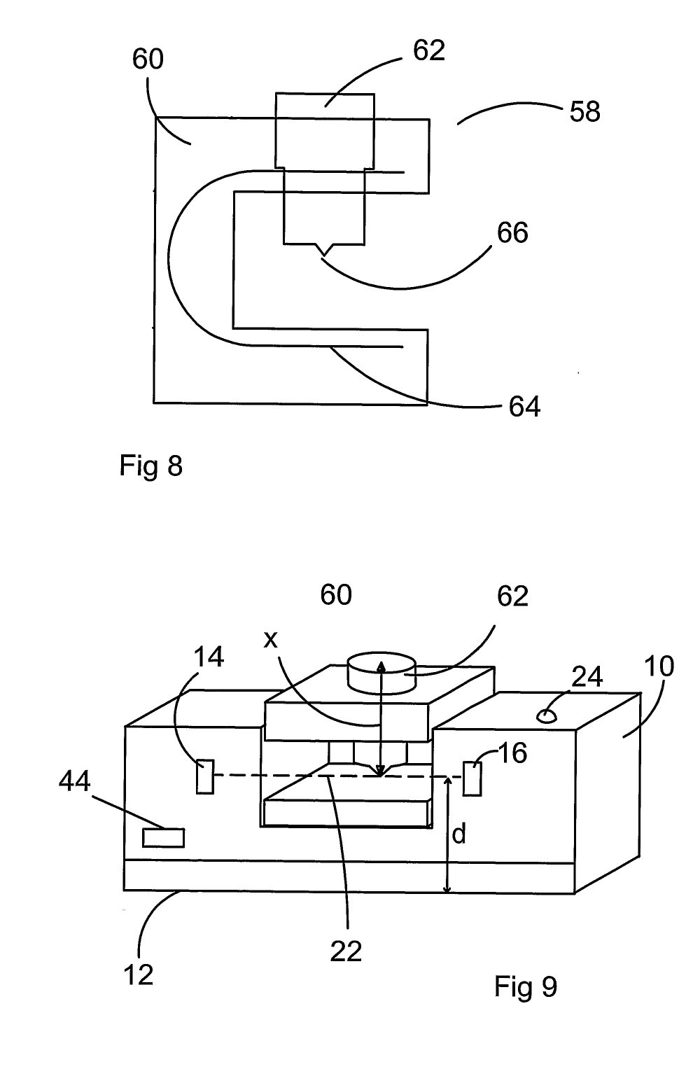

FIG. 8 shows a side view of a plunger system for use with large objects; and

FIG. 9 shows a perspective view of the plunger system of FIG. 8 positioned within the apparatus.

Apparatus for detecting the presence, tip position and width of an object, such as a tool, is illustrated in FIG. 1. The apparatus comprises a housing 10, a datum surface 12, a light source 14 and a light detector 16. The housing has a recessed portion 18 into which the object may be inserted. The light source 14 and detector 16 are arranged on opposite sides of the recessed portion 18 so that the light path 22 between the light source 14 and detector 16 crosses the recessed portion 18. The light detector 16 is connected to a signal means 24, for example a light, which is activated when an object is present between the light source 14 and the light detector 16 causing the light path 22 to become fully or partially obstructed.

FIG. 2 illustrates a plan view of the housing. The light source 14 and light detector 16 are contained in separate compartments 26, 28 within the housing 10, and each compartment has a window 30, 32, through which the light from the light source 14 may pass.

The housing 10 covers the light source 14 and light detector 16, as far as possible preventing contamination from entering into the system. The housing also enables the light source and detector to be positioned relative to each other and to the recessed portion 18.

The windows 30, 32, which can be made of glass, help to prevent optics from becoming contaminated and enable the apparatus to be easily cleaned if any contamination is detected.

As illustrated in FIG. 1, the housing 10 is provided with a datum surface 12, lying substantially parallel to and a defined distance d away from the light path 22 between the light source 14 and light detector 16. The datum surface 12 enables the apparatus to be placed on a surface without requiring subsequent adjustment to align the light path 22 relative to the surface. This is due to the fixed relationship between the light path 22 and the datum surface 12.

The datum surface 12 may be created by accurately machining the base of the housing 10 to a flat surface. Alternatively the datum surface 12 may comprise, for example, three machined surfaces on the base of the housing.

The light path 22 is a defined distance d, e.g. 40 mm, from the datum surface 12. This allows the position of the tip 36 of the tool 20 (illustrated in FIG. 1) to be determined with respect to the surface on which the housing 10 is mounted, e.g. the bed of a machine tool or a work piece mounted on a machine tool. When the tool 20 breaks the light path 22 the tip of the tool 36 is a distance d from the datum surface 12 and thus the surface on which it is mounted. This saves time, as the position of the surface of the work piece does not need to be determined in addition to the position of the tip of the tool 36.

The datum surface 12 enables the apparatus to be removably positioned on different surfaces without the light path 22 requiring adjustment. The apparatus may thus be battery operated which has the advantage of portability.

The light source 14 may comprise for example an LED or a laser. In this embodiment, an LED with a bond wire at the side is used. This arrangement of the bond wire at the side rather than at the front prevents a shadow from the wire being cast across the light detector 16 resulting in a more uniform output of light.

FIG. 2 shows the light source 14 in more detail. A ball lens 34 is positioned in front of the light source 14. This helps to give a more uniform light distribution across the light detector 16.

As illustrated in FIG. 2, the light detector 16 may comprise a linear CMOS array comprising individual CMOS elements 38. However, any linear array may be used, for example a CCD array or an array of individual photodiodes. Use of a linear CMOS array or other linear array has the advantage that the light path 22 between the light source 14 and light detector 16 has a greater width than if a single detector element was used, effectively forming a ‘curtain’ of light. Thus, in order to be positioned within the light path 22, the tool 20 need not be at an exact predefined position but merely in an approximate locality within the width of the light detector array 16. This feature is beneficial for a removable apparatus, as the wider light path has the advantage that the housing can be positioned on a surface approximately below a tool. The housing need only be positioned with sufficient accuracy for the tool to be moved into the light path within the width of the CMOS array.

A CMOS array has the additional advantage that it gives a digital representation of the data outputs, therefore decreasing the amount of electronics required. This is useful in a battery-operated device, as less power is required.

The light source 14 may be pulsed. This extends the battery life and allows the LED to work at a current higher than would be possible if it was run continuously. The light detector 16 may be pulsed in synchronisation with the light source 14.

Signal means 24 are provided to indicate the presence of the tool 20 between the light source 14 and the light detector 16 by for example switching on a light, sounding a buzzer, or producing a digital display. In this embodiment the signal means 24 is a light comprising an LED.

The apparatus has two modes of operation. In a first mode the tool tip position is measured with respect to the datum surface. The tool is lowered into the light path 22 between the light source 14 and the light detector 16. The outputs of each element in the light detector 16 are read whilst the tool 20 is lowered into the light path 22. The light intensity values of each element 38 of the light detector 16 are compared to set threshold values. In this mode the threshold is set at approximately 80% of the intensity measured at each individual element in the absence of an object in the light path 22 between the light source 14 and the light detector 16. A decrease in light intensity below the set threshold value at any one of the individual detector elements triggers a tool found signal. The position of the spindle of the machine tool is recorded when the tool found signal occurs.

The height d of the light path 22 above the base of the housing is known. Therefore, when the tool found signal is output, the tip 36 of the tool 20 is a distance d from the base of the housing, and thus the surface on which the housing is mounted (e.g. machine bed or surface of work piece).

The ability to directly determine the tool tip 36 position with respect to the work piece by mounting the apparatus directly on the work piece without calibration of the apparatus saves time, as it is not necessary to find the position of the surface of the work piece in addition to the position of the tip of the tool 36.

In this arrangement the tool 20 is typically rotated as it is lowered. This rotation is required to account for the profiles of different tools. For example, a tool may have a chiselled profile, in which the tool tip has a different profile at 0° and 90°. FIG. 3 illustrates the tool 20 partially obscuring the light incident on the light detector 16 causing the intensity at one of the light detector elements 38 to decrease. When the tool 20 causes the reduction of detected light intensity at any element to a level below the threshold, the tool found signal is triggered.

In this mode the threshold is typically set at approximately 80% of the initial light intensity detected at each light detector element. This value is carefully chosen to minimise false triggers due to noise and ambient light, whilst enabling the apparatus to still detect small tools. A low percentage may lead to an unacceptable level of undetected tool presence particularly for very small tools, which may for example have a width smaller than one element. A high percentage may lead to an unacceptable level of false triggers due to noise, for example ambient light and noise from electronics.

In a second mode the width of the tool 20 is measured. In this mode only one light sensitive element of the light detector 16 is active, thus a beam rather than a curtain of light is detected. FIG. 3 illustrates a light detector 16 having a linear array of light sensitive elements 38, with only a single element 38A being active.

FIG. 4 illustrates the method of determining the width of a tool 20. The tool 20 is moved into the beam from each side in turn (i.e. along directions A and B as shown by the arrows) until the light intensity at the light sensitive element 38A of the light detector array 16 is below the threshold, causing a tool found signal to be produced. The position of the spindle holding the tool 20 is recorded at the time the tool found signal is produced for movement of the tool in each direction.

The threshold for the signal to trigger is preferably set at 50%, thus when the intensity of light detected drops to half its original value the signal is triggered. This has the advantage that as the tool found signal is triggered when the beam is 50% obscured, it occurs when an edge of the tool 20 is at the centre line of the beam when the tool 20 approaches from each direction.

As the co-ordinate position (x, y, z) of the spindle holding the tool 20 is recorded for each of the two trigger points corresponding to movement of the tool 20 in the two directions, the diameter of the tool can be calculated as the distance between the two co-ordinate positions. FIG. 5 illustrates the two positions of the tool 20A 20B at which a trigger signal is generated (i.e. when the beam 40 is obscured by 50%). The centre lines 42A, 42B are derived from the position of the spindle at the trigger points. The width w of the tool 20 is the distance between the centre lines 42A and 42B. The choice of a 50% threshold allows the width w of the tool 20 to be calculated easily, without knowing the width of the beam 40.

In this arrangement the tool 20 is rotated as it is moved into the beam 40 to give the widest diameter of the tool 20. This prevents smaller readings being produced if the tool 20 is, for instance, profiled or broken on one side. Rotating the tool 20 whilst measuring its width results in the run out of the tool being included in the tool width measurement. This is advantageous as the size of the feature produced by the tool depends on the width of the tool including run out.

A switch 44 (shown in FIG. 1) is provided to switch between the two modes. In a first position the switch 44 selects all elements 38 of the CMOS linear array 16 to be active as required in the first mode. In a second position the switch 44 selects only one element 38A of the CMOS linear array to be active as required in the second mode.

The level of light intensity falling on the light detector 16 required to trigger a tool found signal must be set to distinguish whether or not the tool is present between the light source 14 and light detector 16. However, with the light source 14 switched on and in the absence of a tool, the intensity of light detected at the light detector 16 will not be completely uniform across its length but will tend to decrease towards the edges in a Gaussian distribution. Setting a single threshold value consisting of a percentage value of the maximum light intensity recorded for the entire light detector array 16 would therefore lead to inaccurate results.

The present invention uses a linear array light detector. This has the advantage that individual thresholds can be set for each element of the array. In this way the device overcomes the problem of varying detected light intensities across the array.

FIG. 6 shows a flow diagram describing the method used to set the thresholds for the individual light detecting elements. The intensity of light incident on each individual element of the array when no tool is present is measured 50. A set percentage of the light intensity detected at each element is calculated 52, and this percentage of the detected light intensity level is set as a threshold 54.

This method of setting individual thresholds compensates for variations in light intensity caused by other factors such as noise, ambient light and contamination, for example dirt on the detector or cover lens.

FIG. 7 is a graph showing the relationship between photo-detector elements and voltage output. Once the thresholds are set the output 100 of the cells of the light detector array when no tool is present should lie between two set voltage values, x and x+a. If any individual cell output drops below the output value x, shown by line 102, it is indicated that there is contamination in the system, in particular on the windows, and the user is able to clean the apparatus before continuing. If however any of the cell outputs lie above the upper boundary x+a, shown by line 104, it is indicated that the ambient light level is too high. The user can therefore adjust the ambient light, for example by moving an interfering source away from the device, before continuing.

Some tools may be too large to fit in the recessed portion of the apparatus. The tip position of such tools cannot be determined using the described apparatus as they are unable to enter the beam path 22 between the light source 14 and the light detector 16. FIG. 8 illustrates one embodiment of a plunger system 58, provided as an extension to the apparatus to enable the determination of the tip position of larger tools with respect to the datum surface.

The plunger system 58 comprises a housing 60, a plunger 62 and a spring 64. The spring 64 sits in the housing and biases the plunger 62 upwards. The plunger 62 and housing 60 are shaped so as to allow the plunger 62 to be moved into the beam path 22 when pressure is applied to the plunger 62 by a tool against the bias of the spring 64. The housing 60 of the plunger system 58 is constructed to fit into the recessed portion of the object detecting apparatus housing 10, it is C shaped to allow the beam to pass without interruption from the light source 14 to the light detector 16.

FIG. 9 shows the plunger system 58 positioned within the recessed portion of the apparatus. The length of the plunger 62, distance x, is known precisely. When the tool found signal is output, the tip 66 of the plunger 62 is a distance d from the base of the housing. Knowledge of distance x therefore enables determination of the distance of the tip of the tool from the datum surface and thus the surface on which the housing is mounted (e.g. machine bed or surface of work piece).

Although the detected object is described in the embodiments as a tool, the apparatus can also be used to determine characteristics of other objects.

1. An object detection apparatus comprising:
a housing;
a light source and a light detector provided in the housing, the light source directing a curtain of light towards the light detector; and
the housing having a base which is provided with a datum surface, wherein the light curtain has a defined distance and angle from the datum surface.

2. An object detection apparatus according to claim 1, wherein the path of the light curtain between the light source and light detector lies substantially parallel to the datum surface.

3. An object detection apparatus according to claim 1, wherein the light source is a light emitting diode.

4. An object detection apparatus according to claim 3 wherein the LED has a bond wire and is mounted with the bond wire in a position where it does not obstruct the light path.

5. An object detection apparatus according to claim 1, wherein the light source is pulsed.

6. An object detection apparatus according to claim 5 wherein the light detector is also pulsed and synchronised with the pulses of the light source.

7. An object detection apparatus according to claim 1, wherein a ball lens is positioned in front of the light source.

8. An object detection apparatus according to claim 1, wherein the light detector comprises an array of light sensitive elements.

9. An object detection apparatus according to claim 8, wherein the array comprises a linear array.

10. An object detection apparatus according to claim 9, wherein the linear array is a CMOS sensor.

11. A datum surface according to claim 1 wherein the datum surface is a flat surface of the base of the housing.

12. An object detection apparatus comprising a light source and a light detector, the light source directing light towards the detector;
wherein the light detector comprises an array of light sensitive elements; and
wherein the apparatus has a first mode of operation in which a first set of the light sensitive elements are operational and a second mode of operation in which a second set of the light sensitive elements are operational.

13. An object detection apparatus according to claim 12 wherein the second set of the light sensitive elements is a subset of the first.

14. An object detection apparatus according to claim 12, wherein the first set of light sensitive elements comprises all the elements in the array.

15. An object detection apparatus according to claim 12 wherein the second set of light sensitive elements comprises a single element in the array.

16. An object detection apparatus according to claim 12 wherein a signal is output when a set threshold of light intensity is received by the light detector, the set threshold being different for the first and second modes of use.

17. A method for calibrating an object detection apparatus, having a light source and a light detector comprising an array of light sensitive elements, the light source directing light towards the detector, the method comprising the following steps, in any suitable order:
measuring the intensity of light incident on each individual element of the array when no object is present between the light source and detector;
calculating a predetermined percentage of the measured light intensity value measured at each element; and
setting the percentage value of each element as a threshold level for that element.

18. A method for calibrating an object detection apparatus as described in claim 17 wherein the method has the additional steps of:
comparing the output of each light-sensitive element with the output of the threshold value of that element; and
producing a signal to indicate when the light intensity at any one element drops below its threshold value.

19. An adapter for an object detection apparatus which detects the presence of an object by obstructing a light path, the adapter comprising:
a housing; and
a plunger mounted within the housing and movable with respect to the housing;
a biasing means acting on the plunger;
the plunger having a surface against which an object may be pushed to move the plunger relative to the housing against the bias of the biasing means.

20. An adapter for an object detection apparatus as described in claim 19 wherein the housing is configured so that the adapter can be mounted in the light path of an object detection apparatus without obstructing the light path.
